(19) United States
(12) Patent Application Publication
(10) Pub. No.: US 2023/0032989 A1
(43) Pub. Date: Feb. 2, 2023

(54) SERIAL DATA COMMUNICATION WITH IN-FRAME RESPONSE

(71) Applicant: Infineon Technologies AG, Neubiberg (DE)

(72) Inventor: Jens Barrenscheen, Muenchen (DE)

(21) Appl. No.: 17/814,370

(22) Filed: Jul. 22, 2022

(30) Foreign Application Priority Data
Aug. 2, 2021 (DE) 102021119998.0

(51) Int. Cl. H04L 69/22; H04L 12/403; G06F 21/64; G11C 7/10

(52) U.S. Cl. CPC H04L 69/22; H04L 12/403; G06F 21/64; G11C 7/1006

(57) ABSTRACT

A method for a bus node includes receiving a first frame via a first data channel. The first frame includes a first header field having first header data and a first payload field having first payload data. The method further includes implementing a read operation at a read address determined by the first header data, and generating a second frame containing at least a second payload field having second payload data. The latter are based on the data read when implementing the read operation. The method further includes transmitting the second frame via a second data channel simultaneously with receiving the first frame via the first data channel, and implementing a write operation on the basis of the first payload data.

This application claims the benefit of German Patent Application No. 102021119998.0, filed on Aug. 2, 2021, which application is hereby incorporated herein by reference.

### TECHNICAL FIELD

The present description relates to the field of frame-based serial data communication via serial data buses such as e.g., SPI (Serial Peripheral Interface), HSSL (High Speed Serial Link), MSB (Microsecond Bus), I2C-Bus (Inter-Integrated Circuit Bus) or the like.

### BACKGROUND

Serial data communication is used in a multiplicity of applications. In this regard, for example, data can be transferred by means of serial data transfer for example between two chips arranged on a circuit board, between two circuits within the same chip or else between two separate electronic control units (ECUs). The subscribers to the data communication between which the serial data transfer takes place are also referred to as bus nodes. A wide variety of standardized serial bus systems are known (in some instances also proprietary standards). The SPI bus, for example, is widely used. The designation “bus” indicates that a plurality of signals or lines are required for communication. In the case of an SPI those include a shift clock signal (usually designated as SCK) and a data frame control signal (usually designated as Chip Select, CSN) besides the data lines (usually designated as MISO and MOSI). These two signals determine the data transfer rate of the serially transferred data and the length of the data frames. In the case of an SPI there are variants with different numbers of data lines for each direction. Particularly for applications with high data rates, use is often made of a plurality of data lines for each direction, e.g. 4 or 8. Hereinafter the data lines for each direction are referred to as a data channel, independently of the number of data lines.

The unit which generates the chip select signal and the shift clock signal is usually called a communication master unit (master bus node, or master for short), whereas the unit which receives these signals is usually called a communication slave unit (slave bus node, slave for short). Accordingly, with regard to the abbreviations mentioned above, MISO stands for Master-Input-Slave-Output (data transfer from the slave to the master) and MOSI stands for Master-Output-Slave-Input (data transfer from the master to the slave).

In many applications, data are transferred bidirectionally and simultaneously in both directions (Full Duplex), the data usually being transferred in short sequences referred to as data frames (frames for short). A frame comprises an amount of data bits or symbols, where the data bits or symbols can have various meanings. In this regard, for example, one group (often referred to as “field”) of data bits/symbols of a frame can represent an identifier (direct identifier or part of a header). An identifier can identify, inter alia, the sender and/or the destination of the data transfer. In particular, the identifier can represent an address to which data are intended to be written or from which data are intended to be read. Furthermore, the identifier can contain a specific command stipulating what is intended to happen with the data to be transferred (e.g., reading or writing). Another field of a frame can contain e.g., data bits/symbols representing the data to be written or the data read out. This field is often referred to as a payload field because it contains the actual payload data. Finally, a further field can contain a checksum that allows error detection (and optionally error correction). The checksum can be calculated e.g., by means of cyclic redundancy check (CRC). However, other methods are known as well, such as e.g., error correcting codes (ECC) or the like.

In some responses a concept is used which is referred to as in-frame response (IFR). That concerns the case in which a frame received by a slave contains in the header an identifier representing an address from which a datum is intended to be read (read address). The read operation is executed immediately after the address has been completely received, and the data read are inserted into the payload field of a response frame, which is sent back to the sender (from the slave back to the master) while the rest of the frame is still being received. The received frame having the read address and the response frame are thus transferred simultaneously in the same time window. The inventor has formulated the object of improving known concepts for serial data transfer with IFR.

### SUMMARY

The object mentioned is achieved by the method as claimed in claim 1 and also by a bus node as claimed in claim 7. The dependent claims relate to various embodiments and further developments.

A method for a bus node is described below. In accordance with one exemplary embodiment, the method comprises receiving a first frame via a first data channel. The first frame comprises at least a first header field having first header data and a first payload field having first payload data. The method further comprises implementing a read operation at a read address determined by the first header data, and generating a second frame containing at least a second payload field having second payload data. The latter are based on the data read when implementing the read operation. The method further comprises transmitting the second frame via a second data channel simultaneously with receiving the first frame via the first data channel, and implementing a write operation on the basis of the first payload data.

A further exemplary embodiment relates to a bus node. In accordance with one exemplary embodiment, the bus node comprises a transmitting and receiving device configured to receive a first frame via a first data channel. The first frame comprises at least a first header field having first header data and a first payload field having first payload data. The bus node further comprises a control logic configured to implement a read operation at a read address determined by the first header data. The control logic is further configured to implement a write operation on the basis of the first payload data. A frame encoder of the bus node is configured to generate a second frame containing at least one second payload field having second payload data based on the data read when implementing the read operation, and the transmitting and receiving device is further configured to transmit the second frame via a second data channel simultaneously with receiving the first frame via the first data channel.

### BRIEF DESCRIPTION OF THE DRAWINGS

Exemplary embodiments are explained in greater detail below with reference to figures. The illustrations are not necessarily true to scale and the exemplary embodiments are not restricted only to the aspects illustrated. Rather, importance is attached to representing the principles underlying the exemplary embodiments. In respect of the figures:

FIG. 1 illustrates one example of a system with two bus nodes connected via an SPI bus;

FIG. 2 schematically illustrates frame-based full-duplex bus communication via a serial bus;

FIG. 3 schematically illustrates the concept of the in-frame response (IFR) in frame-based serial bus communication;

FIG. 4 illustrates one example of a method implemented in a slave bus node for safeguarding the response frames by means of checksums with the use of in-frame responses;

FIG. 5 illustrates one example of a method implemented in a master bus node for checking the checksum contained in a response frame with the use of in-frame responses;

FIGS. 6 and 7 schematically illustrate frame-based data transfer for a read access and a write access;

FIG. 8 illustrates one example of a new frame type for the read access with an embedded write command;

FIG. 9 illustrates a further example of a new frame type for the read access with an embedded write command; and

FIG. 10 is a flow diagram for illustrating one example of the method described here.

### DETAILED DESCRIPTION OF ILLUSTRATIVE EMBODIMENTS

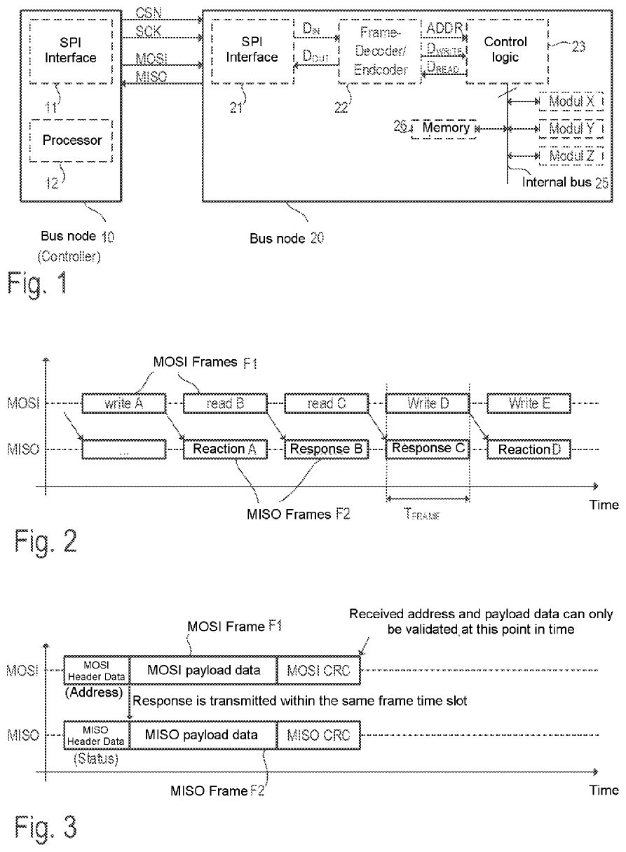

FIG. 1 illustrates one example of a system with two bus nodes connected via an SPI bus. However, the exemplary embodiments described here are not restricted to an SPI bus, rather the concepts described here can also be applied to any other serial bus systems such as e.g., HSSL (High Speed Serial Link), MSB (Microsecond Bus), I2C-Bus (Inter-Integrated Circuit Bus) or the like.

The bus node 10 shown in FIG. 1 is referred to hereinafter as controller or as master bus node, which controls the bus communication. The bus node 10 can be for example a microcontroller having an SPI interface 11 and at least one processor 12 configured to execute software instructions contained in a memory in order to implement the concepts, functions and method steps described here. Programmable microcontrollers having SPI interface are known per se and are therefore not described in greater detail here. It goes without saying, however, that the bus node 10 need not necessarily have a processor for executing software instructions. In addition or instead, it is also possible to use a hardwired or one-time programmable (OTP) logic. A combination of software and hardwired logic is also possible.

The SPI interface 11 of the bus node 10 is connected to a corresponding SPI interface 21 (generally referred to as a transmitting and receiving device) of a further bus node 20 via a plurality of bus lines, which in the case of an SPI bus are usually designated by CSN (Chip Select), SCK (Serial Clock), MOSI (Master Out Slave In) and MISO (Master In Slave Out). The signals transferred via the respective bus lines are likewise designated by CSN, SCK, MOSI and MISO. The master bus node stipulates the points in time at which frames are transmitted (by activation of CSN) and also the data transfer rate (generation of the clock signal SCK). Moreover, the master bus node also defines whether and which data are read or written (as viewed from the master bus node in each case).

In some applications, the signal CSN is optional. It is used in particular if a plurality of slave bus nodes are connected to a master bus node. In other applications, CSN is indispensable. By way of example, CSN may be incorporated in a safety concept of a component. The clock signal SCK is usually a shift clock signal generated by the master bus node 10 for the synchronization of the data transfer on the data channels MISO and MOSI. The data channel MOSI (having at least one data line) serves for data transfer from the master bus node 10 to the slave bus node 20 (downlink), and the data channel MISO (having likewise at least one bus line) serves for data transfer in the other direction (uplink). In the case of a full duplex data transfer, data are transferred on both data channels, MOSI and MISO, simultaneously and synchronously with the shift clock signal SCK. In the case of application of the abovementioned concept of in-frame response (IFR), therefore, the frame transmitted by the master bus node 10 and the corresponding response frame transmitted by the slave bus node 20 are transferred simultaneously (in the same time window determined by the signal CSN) and synchronously with the shift clock signal SCK.

As described above, the serial data transfer is effected on the basis of frames (MOSI frames from the bus node 10 to the bus node 20; MISO frames from the bus node 20 to the bus node 10). The structure of a frame will be explained in even greater detail later. In the bus node 20 the data DIN received by the SPI interface 21 are forwarded to a frame decoder/encoder 22. In the other direction, the frame decoder/encoder 22 supplies the data D_{OUT} to be transferred to the SPI interface. The frame decoder/encoder 22 is configured firstly to “unpack” and optionally validate the data contained in a MOSI frame and to “pack” the raw data to be transmitted in a MISO frame and optionally to safeguard them using a checksum or the like.

Validating and safeguarding data contained in a frame usually comprises calculating or verifying a checksum. In some of the exemplary embodiments described here, the cyclic redundancy check (CRC) is used for calculating and verifying checksums, although other algorithms for ascertaining and verifying checksums are also possible. In the simplest case, the checksum includes one or more parity bits. Various CRC methods or CRC polynomials and other methods for ascertaining and verifying checksums are known per se and are therefore not explained in detail here. In general, the frame decoder/encoder 22 adds a checksum to those (raw) data D_{READ} which are packed into a frame (to be transmitted), and verifies the checksum contained in a (received) frame in order to check the integrity of the received data (e.g., an address ADDR, D_{WRITE}). However, safeguarding data by means of checksums is not absolutely necessary and can be omitted in less critical applications.

In the case of a write access, bus node 10 writes data D_{WRITE} to the address ADDR in the bus node 20. For this purpose, D_{WRITE} and ADDR have to be transferred in one or more MOSI frames. In the case of a read access, bus node 10 reads data D_{READ} from an address ADDR of bus node 20. For this purpose, it is necessary to transfer the address ADDR in at least one MOSI frame and the read data D_{READ} in at least one MISO frame. The address ADDR identifies a memory location in the modules or memory areas of the bus node 20 to which data can be written.

In the present example, the data received in a MOSI frame in the (slave) bus node 20 are designated by D_{WRITE} and ADDR and are fed to a control logic 23. The data transmitted in a MISO frame by the bus node 20 are output by the control logic 23 to the frame decoder/encoder 22 and are designated by D_{READ} in the present example. The construction of a frame and the meaning of the data contained therein will be explained in even greater detail later (cf. FIG. 3). The control logic 23 can access a memory 26 and also one or more modules X, Y, Z e.g., via an internal data bus 25. A module can be an arbitrary data source or data sink. In one simple example, a module is a simple semiconductor switch that can be switched on or off by means of a specific command or that supplies on request a value for the current flowing via the (closed) switch. A module can also be a sensor that regularly supplies updated measurement values (e.g., a temperature). In one simple example, a memory is an element that can store written data and provides them for read-out again as necessary (e.g., on the basis of flip-flops, RAM cells, etc.).

FIG. 2 schematically illustrates frame-based full-duplex data transfer via a serial bus, wherein a sequence of frames is in each case transferred both via the MOSI data channel and via the MISO data channel. In the example illustrated, the frames F1 (i.e., the data contained therein) transferred via the MOSI data channel can be interpreted as commands, for example as write and read commands (e.g., “write A”, “read B”, etc.). The frames F2 transferred via the MISO data channel contain the responses to the respective commands (e.g., the data read out from a register).

The frames F1 and F2 are transferred simultaneously. In the examples described here, “simultaneously” is understood to mean that the two frames (from and to the master) overlap at least temporally. In one exemplary embodiment, in a specific time interval in which a MOSI frame is transferred, a MISO frame is also transferred simultaneously (cf. e.g., FIG. 2, time interval T_{FRAME}). Particularly in the case of an SPI, the transfer is isochronous since both frames (apart from unavoidable propagation delay effects) begin and end substantially at the same point in time. The frames F1 and F2 can be transferred synchronously with a clock signal (which is generated by the bus node 10 and output to the SCK line), as is the case e.g., for a simple SPI bus. For higher data rates (e.g., above 10 Mbauds) the frames F1 and F2 can refer to separate SCK signals.

In systems with a next-frame response (NFR) structure, the response to a command transferred in a MOSI frame is only transferred in a temporally succeeding MISO frame. In this case, the MISO frames F2 lag behind the corresponding MOSI frames F1 temporally by at least one frame duration. This time offset is undesired in some applications, however, for which reason a concept known as in-frame response (IFR) was developed. One example of this is illustrated in FIG. 3.

As illustrated in FIG. 3, each frame (MOSI and MISO frames) comprises at least a first field with header data, a second field with payload data and a third field with a checksum. The slave bus node (e.g., bus node 20) can implement a specific function depending on the data contained in a MOSI frame F1. Said function can be dependent e.g., on the header data. By way of example, the header data can designate an address (e.g., a register address) for a write or read operation. A portion of the header data (just one bit in a simple case) indicates whether a write or read operation is to be implemented. However, the information concerning the function/operation to be implemented can also be considered as part of the address. In the case of a write operation, the data to be written are in the payload data field of the MOSI frame F1. In the case of a read operation, the payload data of the MOSI frame F1 can also be dummy data (e.g., a sequence of zeros) since they are not taken into consideration any further functionally by the slave bus node. The checksum in the checksum field of the MOSI frame F1 (MOSI CRC) safeguards the data of the MOSI frame that are contained in the header field and in the payload field. That means for the example illustrated that the CRC checksum (MOSI CRC) is calculated in the master bus node 10 on the basis of the header data and the payload data.

In the case of an in-frame response, the slave bus node 20 already implements the function (e.g., a read operation) requested by the master bus node as soon as the header data of the MOSI frame F1 have been received. The MOSI CRC value has not yet been completely received and evaluated at this point in time. The response (e.g., the data D_{READ} read from a register at the location ADDR) is transferred in the payload field of the MISO frame F2 while the corresponding MOSI frame F1 is still being received. The header data of the MISO frame F2 can be dummy data (e.g., a sequence of zeros), may depend on the currently received MOSI header data, or can be e.g., status information indicating the current status of the bus node 20 (e.g., independently of the currently implemented operation). In one example, the header data (ADDR) currently received in the MOSI frame F1 are copied bit by bit into the header data field of the MISO frame F2 (status information identical to MOSI header data). The checksum in the checksum field of the MISO frame F2 (MISO CRC) protects the payload data of the MISO frame F2 and optionally also the header data of the MISO frame F2. That means for the example illustrated that the CRC checksum (MISO CRC) is calculated in the slave bus node 20 (e.g., in the frame decoder/encoder 22) on the basis of the payload data and optionally also on the basis of the header data of the MISO frame F2.

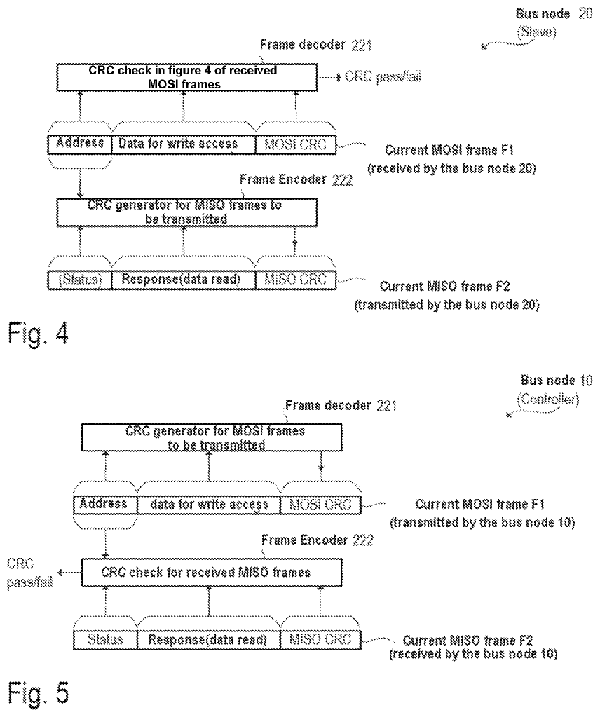

It can already be discerned from the temporal sequence illustrated in FIG. 3 that at the point in time at which the slave bus node 20 has received the header data (e.g., the address ADDR for a read operation) of the MOSI frame F1, the requested function (e.g., the read operation) should be implemented immediately even before objectively there is a possibility of verifying the checksum (MOSI CRC) in order to validate the data received by the slave bus node 20. At a point in time at which the frame decoder/encoder 22 in the slave bus node 20—possibly—establishes that the received frame F1 is erroneous, the frame F2 with the response has already been transmitted back to the master bus node 20. In the case where the verification of the checksum (MOSI CRC) fails (e.g., as a result of a transfer error of the read address ADDR), the slave bus node 20 would only notice afterward that the response to an “incorrectly understood question” has been transmitted. However, only with the next MISO frame F2 is the slave bus node 20 able to inform the master bus node 10 about the erroneous checksum, which would at least partly nullify again the advantage of the in-frame response. In the following FIGS. 4 and 5 a concept is elucidated which makes it possible that the master bus node 10, already on the basis of that MISO frame which contains the in-frame response, can assess whether the slave bus node 20 has performed the correct function (and has “correctly understood” the question). If the header of the MISO frame F2 contains a copy of the read address, the bus node 10, after receiving the MOSI frame, can compare the actual read address (from the MISO frame F2) with the originally desired read address (incorporated in the MOSI frame F1) and react accordingly. In some cases, the header field in the MISO frame F2 is provided with other data (status, etc.), such that the actual read address cannot be completely transferred in the MISO frame F2.

FIG. 4 illustrates the process of verifying the checksum (MOSI CRC) contained in the MOSI frame F1 and also generating/calculating the checksum (MISO CRC) to be transmitted in the MISO frame F2 in a slave bus node 20 (cf. FIG. 1). The frame decoder/encoder 22 contained in the bus node 20 can be functionally divided into two parts, which are designated hereinafter as frame decoder 221 and frame encoder 222. The frame decoder 221 receives the data D_{IN} of a received MOSI frame and extracts therefrom the header data (e.g., address ADDR for write access), payload data (e.g., the data word D_{WRITE} to be written) and checksum (MOSI CRC) contained therein. The frame decoder 221 is further configured to verify the received checksum. If a checksum error is detected, then e.g., a process of writing to an address is not performed, but for example a predetermined value is indicated in an error register. During the verification of the checksum, the latter is calculated on the basis of the header data and the payload data of the received MOSI frame F1 and is compared with the received checksum in the checksum field. In the event of deviations between the calculated checksum and the received checksum, an error is signaled. The complete check and the process of writing with data that are safeguarded (by means of CRC) can only take place after the complete MOSI frame has been received (e.g., after the deactivation of the CSN signal).

In the present example, before implementing the write operation, the content of the addressed register is read out (data word D_{READ}) and the data word D_{READ} read is sent as an in-frame response to the write command back to the bus node 10 (master node). Directly after receiving the destination address ADDR in the MOSI header data field (still before the check of the MOSI CRC), the control logic 23 performs a read operation at the received address ADDR and transfers the data read there to the frame encoder 222. The frame encoder 222 receives the data word D_{READ} (e.g., from the control logic 23) and also status information and generates therefrom the MISO/response frame F2 to be transmitted, wherein the MISO header data represent the status information and the MISO payload data represent the data word D_{READ}. The frame encoder 222 is configured to calculate a checksum on the basis of the MOSI header data (address) of the presently received MOSI frame F1, the MISO payload data of the presently current MISO frame F2 and optionally also on the basis of the MISO header data of the presently current MISO frame F2. The calculated checksum value MISO CRC is written into the checksum field of the current MISO frame F2 and transferred via the bus to the master bus node 10. As already mentioned, the received MOSI frame F1 and the response frame F2 (MISO frame) are transferred in parallel in the same time slot. In the case of an SPI interface, the MOSI and MISO frames are transferred simultaneously and isochronously (in a manner controlled by the common signals CSN and SCK). In the case of other transfer interfaces, MOSI and MISO frames can be transferred with a temporal offset relative to one another. As soon as a slave bus node initiates an action in response to an only partly received MOSI frame (still before the check of the complete MOSI frame), it is possible to apply the mechanisms described here for safeguarding the MISO frame.

In contrast to known concepts, the header data contained in the presently received MOSI frame F1 are taken into account, as illustrated schematically in FIG. 4 in the responding slave bus node 20 during the calculation of the checksum for safeguarding the MISO/response frame F2. In this case, the slave bus node 20 uses data for creating the MISO checksum which originate from the current frames F1 and F2 which are transferred at the same time or in an overlapping manner.

The master bus node 10 receives by way of its SPI interface 11 (see FIG. 1) a MISO/response frame F2 (data D_{OUT} transmitted by the slave bus node) and implements the verification of the checksum (MISO CRC) contained in the received MISO/response frame F2, on the basis of the MOSI header data (address) that were used previously for generating the MOSI frame F1 transferred at the same time as the MISO frame F2 or in a manner overlapping the latter, and also on the basis of the MISO payload data of the presently received MISO/response frame F2 and optionally on the basis of the MISO header data of the presently received MISO/response frame F2. This is illustrated in the lower part of FIG. 5. The upper part of FIG. 5 illustrates the safeguarding of a MOSI frame F1 to be transmitted in the master bus node 10, for which the checksum (MOSI CRC) is calculated on the basis of the MOSI header data (address) and the MOSI payload data of the relevant frame in a conventional manner.

During the verification of the checksum of the received MISO/response frame F2, the master bus node 10 can already recognize whether the slave bus node 20 has correctly received the MOSI header data (which contain e.g., the address for a write or read operation) of the corresponding MOSI frame F1. If that were not the case, then the header data (of the MOSI frame F1) received in the slave bus node 20 would not be the same as those used for the generation of the MOSI frame in the master bus node 10 (in this case, the slave bus node 20 would have “incorrectly understood” the master bus node 10). Since the received MOSI header data are taken into account in the checksum calculation in the slave bus node and the intended MOSI header data are taken into account in the checksum verification in the master bus node, during the verification of the checksum of a received MISO/response frame the master bus node can immediately recognize whether the slave bus node 20 has correctly received the header data of the corresponding MOSI frame (and thus the information about the function/operation to be performed).

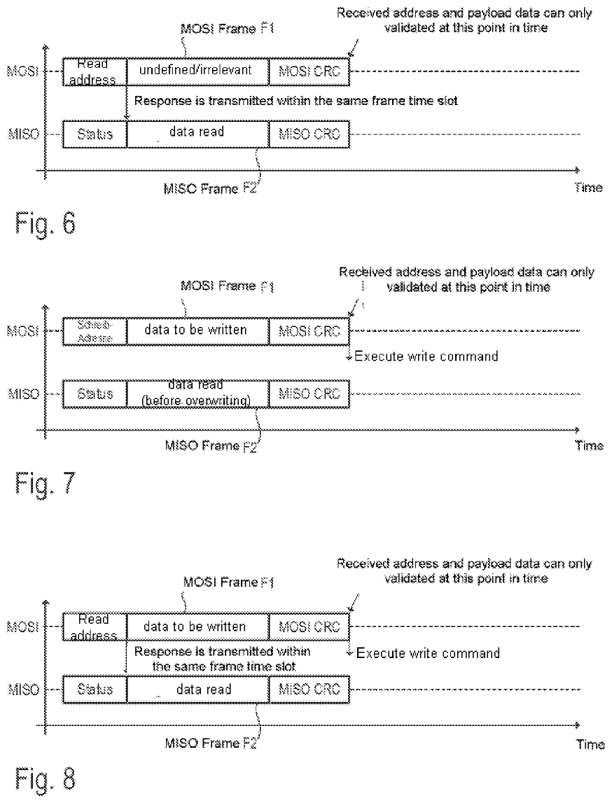

FIGS. 6 and 7 schematically illustrate a MOSI frame F1 for a read access and respectively a MOSI frame F1 for a write access and also the associated MISO/response frames F2. In the present example, the read command and respectively write command are part of the address, that is to say that different address areas are used for read and write operations. The response to a MOSI frame F1 with a read command is effected directly in the MISO frame F2 transferred in a manner temporally overlapping (through to practically simultaneously with) the MOSI frame F1. However, as discussed above, the received read address can only be validated at the end of the frame, i.e. after the frame has been completely received. In the present example, the in-frame response to a MOSI frame F1 with a write command contains the data stored before overwriting at the write address. In other examples, other data (e.g., status information, dummy data, etc.) can also be transferred in the response frame F2.

As illustrated in FIG. 6, for a read access, the payload data of the MOSI frame F1 are irrelevant or undefined. That is to say that the payload data field of the frame F1 is not used since all information necessary for the read access (i.e., the read address) is contained in the header field. Since MISO frames and MOSI frames are usually transferred simultaneously and synchronously with a clock signal, and, therefore, at least the frame control signal is identical (e.g., CSN in the case of an SPI bus), the MOSI frame for a read access actually cannot be shortened. A concept is described below according to which the payload data field in a MOSI frame whose header field contains a read address can be used to make the communication between master bus node/controller 10 and slave bus node 20 more efficient. One example is illustrated in FIG. 8.

In accordance with the example from FIG. 8, in the MOSI frame F1, a read address for a read access is transferred in the header field and payload data are transferred in the payload data field, said payload data being written to one or more defined memory locations in the slave bus node 20 that receives the frame F1. The corresponding MISO frame with the in-frame response to the read command is generated in the same way as explained above with reference to FIG. 6. The payload data in the payload data field of the received MOSI frame F1 are only written after the frame has been completely received. If the frame is provided with a checksum, the write operation takes place only when the data contained in the frame have been validated (e.g., by means of CRC).

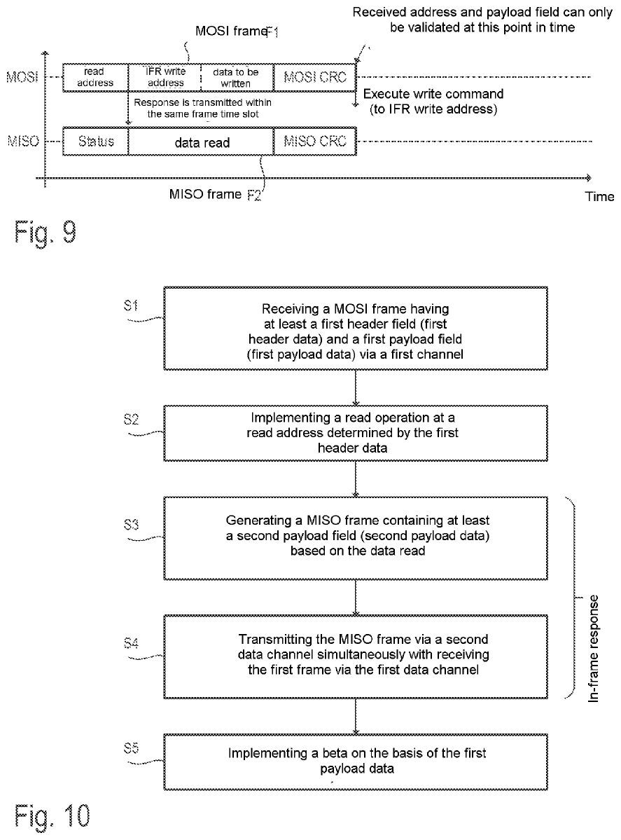

The payload data in the payload data field of the received MOSI frame F1 can be e.g., control bits, status flags, configuration data or the like, which are written to a predetermined memory area, for example in order to configure the slave bus node for a desired purpose or a desired operating mode. In a further example, the payload data field of the received MOSI frame F1 contains both a write address and the data to be written to this address. This situation is illustrated in FIG. 9, which is identical to FIG. 8 apart from the payload data field of the MOSI frame F1. In one example, a frame can have a length of 32 bits, the header field having 8 bits, the payload field having 16 bits and the checksum likewise having 8 bits. In this example, an 8-bit write address and 8 bits of data to be written, for example, can be transferred in the payload field. This division into two times 8 bits is not mandatory, however. In another example, a 4-bit write address and 12 bits of data to be written can be transferred. The concrete embodiment depends on the application. The write command is executed, of course, only after the frame has been completely received and optionally after the received data have been validated by means of CRC.

A write operation does not necessarily mean that exactly the payload data contained in the payload data field are written. A write operation may also include existing data (e.g., status flags) being modified, wherein the type of modification may depend on the payload data contained in the payload data field. Furthermore, writing to an address also does not necessarily mean that data are actually stored in a memory. The writing of (payload) data to an address can also initiate a specific action, which may depend on the (payload) data, e.g. erasing status information or advancing a state machine. Furthermore, the payload field need not necessarily contain the write address directly; instead, the payload field can also contain a pointer that refers to the actual address. In general terms, the payload field contains firstly information regarding a write address (e.g., the address itself or a pointer) and secondly data which in some way determine/indicate what is intended to be written to the write address or how the data are to be modified at the write address.

The frame type in accordance with FIG. 9 (read access with embedded write access) can completely replace the frame type in accordance with FIG. 7 (normal write access). Depending on the application, it is also possible for both types to be used. In applications in which significantly more read accesses and write accesses take place during operation, the new frame type in accordance with FIG. 9 has the advantage that the (few) write commands can be transferred practically “piggyback” on the frames for the read accesses. That is to say that practically no additional bus communication is possible for write accesses.

In the previous example with a frame length of 32 bits (header 8 bits, payload 16 bits, checksum 8 bits), the amount of memory that is addressable in the case of the new frame type in accordance with FIG. 9 is also just as much as in the case where conventional write accesses are used (cf. FIG. 7). In the case of a conventional write access, 7 bits of the header field can be used for the address (the eighth bit of the header serves to distinguish between read access and write access), while 16 bits of payload data (2 bytes) can be written in one operation. That yields an addressable memory of 256 bytes (128 addresses each for 2 bytes). With the embedded write command of the new frame type (cf. FIG. 9), 8 bits can be used for the address (first half of the payload field), while 8 bits (1 byte, second half of the payload field) can be written in one operation. That likewise yields an addressable memory of 256 bytes (256 addresses each for 1 byte).

The concept of a frame for the read access with an embedded write command as illustrated in FIGS. 8 and 9 is summarized below with reference to the flow diagram in FIG. 1. It is understood that the steps designated by S1-S5 do not imply a temporal sequence. Rather, they proceed simultaneously in part, which is also reflected by the designation “in-frame response”. FIG. 10 relates to a method which is carried out in a bus node, for example the slave bus node 20 illustrated in FIG. 1. Accordingly, the method comprises receiving a first frame (MISO frame) via a first data channel (cf. FIG. 10, step S1), wherein the MISO frame comprises at least a first header field having first header data and a first payload field having first payload data. The method further comprises implementing a read operation at a read address determined by the first header data (cf. FIG. 10, step S2), and generating a second frame (MISO frame) containing at least a second payload field having second payload data based on the data read in step S2 (cf. FIG. 10, step S3). The method further comprises transmitting the second frame via a second data channel with a temporal overlap or simultaneously with receiving the first frame via the first data channel (cf. FIG. 10, step S4), and implementing a write operation on the basis of the first payload data (cf. FIG. 10, step S5).

Receiving the first frame (MOSI frame) and transmitting the second frame (MISO frame, response frame) take place with a temporal overlap or simultaneously, hence the name in-frame response. Implementing the read operation can take place directly after receiving the first header data, and even before the MOSI frame has been completely received. The two frames (MISO and MOSI frames) can be transferred in the same time interval (cf. FIG. 2, time interval T_{FRAME}). Both frames are usually transferred synchronously with a clock signal.

In one exemplary embodiment, the MOSI frame additionally contains a checksum. In this case, the write operation is implemented only after successful checking of the checksum. The first payload data (of the received MOSI frame) can contain both information regarding a write address and a (payload) data word. In this case, implementing the write operation comprises writing data based on the data word to an area of one or more memories that is specified by the write address.

Since the read operation is executed even before the entire MOSI frame has been completely received and validated, the checksum of the MOSI frame need not necessarily comprise the read address. In one example, the MOSI checksum can concomitantly comprise the read address in order to be able to concomitantly analyze this part of the frame as well, e.g. with regard to disturbances present during the transfer.

What is claimed is:

1. A method comprising:
receiving a first frame via a first data channel, wherein the first frame comprises at least a first header field having first header data and a first payload field having first payload data;
implementing a read operation at a read address determined by the first header data;
generating a second frame containing at least a second payload field having second payload data based on the data read when implementing the read operation;
transmitting the second frame via a second data channel with a temporal overlap with receiving the first frame via the first data channel; and
implementing a write operation on the basis of the first payload data.

2. The method as claimed in claim 1,
wherein the first frame additionally contains a checksum and the write operation is implemented only after successful checking of the checksum.

3. The method as claimed in claim 1,
wherein the first payload data contain information regarding a write address and a data word, and wherein implementing the write operation comprises writing data based on the data word to the write address.

4. The method as claimed in claim 1,
wherein the second frame is transmitted in the same time interval in which the first frame is received.

5. The method as claimed in claim 1,
wherein the first frame and the second frame are received and respectively transmitted synchronously with a clock signal.

6. The method as claimed in claim 1,
wherein implementing the read operation takes place directly after receiving the first header data and even before the first frame has been completely received.

7. A bus node comprising:
a transmitting and receiving device configured to receive a first frame via a first data channel, wherein the first frame comprises at least a first header field having first header data and a first payload field having first payload data;
a control logic configured to implement a read operation at a read address determined by the first header data, and further configured to implement a write operation on the basis of the first payload data; and
a frame encoder configured to generate a second frame containing at least a second payload field having second payload data based on the data read when implementing the read operation;
wherein the transmitting and receiving device is further configured to transmit the second frame via a second data channel with a temporal overlap with receiving the first frame via the first data channel.

8. The bus node as claimed in claim 7,
wherein the first frame additionally contains a checksum and the control logic is configured to implement the write operation only after successful checking of the checksum.

9. The bus node as claimed in claim 7,
wherein the first payload data contain information regarding a write address and a data word, and
wherein implementing the write operation comprises writing data based on the data word to the write address.

10. The bus node as claimed in claim 7,
wherein the control logic is configured to implement the read operation directly after receiving the first header data even before the first frame has been completely received.
